(19) United States
(12) Patent Application Publication
(10) Pub. No.: US 2007/0285423 A1
(43) Pub. Date: Dec. 13, 2007

(54) Splat Lights

(75) Inventor: Mitch Prater, Fairfax, CA (US)

Correspondence Address: JONATHAN M. HOLLANDER;PIXAR - HOLLANDER, 73 SUMNER ST., SUITE 301, SAN FRANCISCO, CA, 94103, US

(73) Assignee: PIXAR, Emeryville, CA (US)

(21) Appl. No.: 11/760,109

(22) Filed: Jun. 8, 2007

Related U.S. Application Data
(60) Provisional application No. 60/812,406, filed on Jun. 8, 2006.

(51) Int. Cl. G06T 15/60

(52) U.S. Cl. 345/426

(57) ABSTRACT

Splat lights apply environmental lighting effects to objects in a scene. Splat light sources bypass all or a majority of the operations of a shader program. The rendered color of an object due to the splat light is specified directly by the color of the splat light. A splat light includes a color, a direction, and an angular range. The illumination of a point on an object from a splat light is determined by a normal vector at that point. The splat light contributes no illumination to points that have normal vectors outside of the angular range of the splat light. Because splat lights specify the illuminated color and intensity of points directly, splat lights produce predictable and consistent illumination on objects. Splat lights can be specified with a user interface that displays splat light indicators positioned on an environmental lighting framework.

### BACKGROUND OF THE INVENTION

The present invention relates to the field of computer graphics, and in particular to methods and apparatus for creating, modifying, and using lights and other components to control the attributes and appearance of objects in computer graphics images.

Many computer graphic images are created by mathematically modeling the interaction of light with a three-dimensional scene from a given viewpoint. This process, called rendering, generates a two-dimensional image of the scene from the given viewpoint, and is analogous to taking a photograph of a real-world scene. Animated sequences can be created by rendering a sequence of images of a scene as the scene is gradually changed over time. A great deal of effort has been devoted to making realistic looking and artistically compelling rendered images and animations.

Lighting makes a substantial contribution to the visual appearance of objects in a scene. Some rendering applications attempt to simulate the physics of lights and their illumination effects on objects in a scene as realistically and accurately as possible. Other rendering applications allow lights and their illumination effects to deviate from real-world physics to provide a greater range of artistic expression.

Many rendering applications use environmental lighting programs, or environmental lights, to determine how ambient or diffuse light from surrounding environment is applied to objects in a scene. Previous lighting systems in rendering applications used light sources, such as point or area lights, placed in different positions within the animation scene to simulate natural light. There are several problems with using traditional light sources to implement environmental lighting.

First, typical light sources in computer graphics systems require the configuration of a large list of possible parameters, such as the light source type, light source shape, light position, direction, field of effect, color, intensity, fall-off, occlusion and shadowing, bidirectional reflection distribution function (BRDF), atmospheric scattering, and other parameters. This parameters are time-consuming to configure. Additionally, because these parameters can interact in unpredictable ways if used incorrectly, users are required to have detailed knowledge of the lighting system and the functions of all of the light parameters to correctly configure lights.

A second problem is that light sources in typical computer graphics systems emit light, but do not directly determine the final rendered color of objects in scenes. Instead, the light emitted from one or more light sources provided as input to a shading program or shader associated with an object. The shader then uses the light source input in combination with other inputs associated with the object itself, such as surface materials, surface geometry, and texture maps, to determine the final rendered color of objects in scenes. Thus, the color of objects in a scene depend on the interaction between lights and surface shaders, rather than just the properties of the lights alone. Because of this interrelationship between lights and shaders, it is often difficult for artists to manipulate the environmental light in a scene. A user may set the color of a light to a desired value, only to have an object rendered in a different color due to the influence of the object's properties and its shader. Moreover, even if a user readjusts a light source to compensate for the influence of one object's properties and shader, the appearance of other objects due to the changes in the light source may be adversely affected.

As a result of these problems, users may spend a considerable amount of time adjusting and readjusting the individual lights to produce the desired affect. Additionally, users may be required to create separate light sources that only affect individual objects in a scene. This process is time consuming, unwieldy, and error prone.

Therefore, a simpler, more efficient, more flexible, and less error-prone system and method for creating, configuring, modifying, customizing, and using environmental lights in computer graphics images.

### BRIEF SUMMARY OF THE INVENTION

Embodiments of the invention include an animated scene rendering architecture for creating, configuring, modifying, customizing, and using lights in computer graphics images.

In one embodiment, a lighting framework is displayed about objects of a graphical scene. To illuminate objects in the scene, a splat light is formed from one or more functions that emulate the illumination of environmental lights such as skylights, lights that are bounced off surfaces, etc., and may be used to emulate point lights. In one embodiment, a splat light source indicator is movably disposed about the lighting framework and configured to provide the user with a visual mechanism to apply the splat light function to objects in the scene. The one or more functions are employed to illuminate objects with respect to an illumination direction and surface orientation of the objects in the scene relative to the position of the splat light source indicator. For example, the splat light indicator allows the user to graphically adjust the direction and extent of the illumination on the objects in the scene by adjusting one or more parameters of the function defining the splat light and illumination direction. In another embodiment, parameters affecting the splat light illumination effect on the objects such as the extent of the illumination, shape of the illumination, illumination intensity, illumination color, shadowing, are adjustable by a user via a graphical user interface (GUI).

In one embodiment, the present invention provides a method to illuminate an animated scene. The method includes forming a lighting framework on a computer display, positioning at least one splat light source indicator on the lighting framework, wherein the splat light source indicator provides a visual reference on the display corresponding to a direction and an extent of illumination effect on objects of the animated scene, wherein the illumination effect is derived from a function that emulates an environmental light source, adjusting the function to illuminate the objects in the animation scene according to a user input, and rendering the illumination of the objects according to the function.

In one embodiment, the present invention provides a computer system for illuminating an animated scene. The system includes at least one processor, a computer readable storage medium coupled to the processor, wherein the computer readable storage medium includes instructions stored therein for directing the processor to illuminate the animated scene. The instructions include code for directing the processor to display a lighting framework display disposed about the animated scene, code for illuminating a surface of an object using a function that emulates illumination from an environmental light source, code for directing the processor to display at least one environmental light indicator used to provide a user with visual feedback of illumination direction and extent of the illumination of the surface, wherein the environmental light indicator is movable about the lighting framework in response to a user input, and code for directing the processor to illuminate the animated scene with light emissions corresponding to the function.

In one embodiment, the present invention provides a computer system for lighting an animated scene. The computer system includes a memory configured to store a function used to emulate illumination of an object in a scene by a environmental light source, a display configured to display a three-dimensional lighting framework about the object and a three dimensional representation of an light source indicator movably disposed about the environmental lighting framework, wherein the light source indicator provides a user a visual reference and control of the direction and extent of the illumination on the object generated by the function, and a processor coupled to the memory, wherein the processor is configured to illuminate the scene using the function adjusted in accordance with one or more illumination parameters.

### BRIEF DESCRIPTION OF THE DRAWINGS

FIG. 1 is a simplified block diagram of typical computer rendering system in accordance with embodiments of the invention;

FIG. 2 is a high-level illustration of a graphical user interface in accordance with embodiments of the invention;

FIG. 3 is a high-level flow diagram illustrating one embodiment of a method of generating a lighting framework in accordance with embodiments of the invention;

FIG. 4 is a high-level illustration of an environmental lighting framework with a splat light source indicator in accordance with embodiments of the invention;

FIG. 5 is a high-level flow diagram illustrating one embodiment of a method of generating a splat light in accordance with embodiments of the invention;

FIG. 6 is a high-level illustration of an environmental light framework with a splat light source indicator in accordance with embodiments of the invention;

FIG. 7 is a high-level flow diagram illustrating one embodiment of a method of manipulating a splat light in accordance with embodiments of the invention;

FIG. 8 is a high-level illustration of an environment light framework with a splat light manipulation in accordance with embodiments of the invention;

FIG. 9 is a high-level illustration of an environment light framework with a resized splat light and corresponding splat light source indicator of FIG. 8 in accordance with embodiments of the invention;

FIG. 10 is a high-level illustration of an environment light framework with splat light source indicator moved to a second position with a color ramp indicator in accordance with embodiments of the invention; and

FIG. 11 is a high-level illustration of splat light source indicator with splat light positioning handle in accordance with embodiments of the invention.

These and other embodiments of the invention are described in further detail below.

### DETAILED DESCRIPTION OF THE INVENTION

Embodiments of the invention are directed to systems and methods for creating, configuring, modifying, customizing, and using lights in computer graphics images. In an embodiment, a new type of light source, referred to as a splat light, allows users to quickly and easily apply environmental lighting effects to objects in a scene. Splat lights provide directional illumination effects that can be used to create environmental light, such as sunlight or moonlight, skylights providing diffused light, and diffuse reflected light emanating from a surface of objects.

Unlike other types of light sources, an embodiment of splat light sources bypass all or a majority of the operations of a shader program. As a result, the rendered color of an object due to the splat light is specified directly by the color of the splat light, without any influence from most attributes of the objects. In an embodiment, a splat light includes a color, a direction, an intensity, and an angular range. The illumination of a point on an object from a splat light is determined by a normal vector at that point. If the normal vector is aligned with the direction of the splat light (e.g. the dot product of the normalized surface normal vector projected outward from the point on the surface and the normalized direction of splat light is negative one), then the point has the color of the splat light at its full intensity. As the normal vector deviates away from the splat light direction, the illumination of that point due to the splat light decreases in intensity. The splat light contributes no illumination to points that have normal vectors outside of the angular range of the splat light.

The illumination from a splat light can be combined with illumination and shading from other light sources, shader programs, and object attributes such as texture maps. However, because splat lights specify the illuminated color and intensity of points on objects directly, splat lights can be used to easily produce a predictable illumination on objects on a scene. Moreover, the illumination from a splat light is consistent across different objects because it is only based on the normal vectors of objects, rather than complex shaders and object attributes.

Because of their simplicity and predictability, users can “paint” a scene with environmental light using splat lights. For example, an outdoor scene at sunset can include an orange splat light in west (facing east) and a dark blue splat light in the east (facing west). This pair of splat lights will illuminate the portions of the scene facing west with an orange color and the portions of the scene facing east with a dark blue color, simulating the general environmental light of an outdoor scene at sunset. In other example, an underwater scene can include a light blue splat light at the top (facing down), simulating the environmental light from the surface of the water.

The use of splat lights can be facilitated in an embodiment with a user interface adapted to apply environmental lighting to objects. In one embodiment, at least one splat light source indicator is positioned on an environmental lighting framework to provide the user with a visual reference of the direction and extent of the illumination effect from the splat light onto the objects in the scene. The splat light source indicator is movable about the environmental lighting framework and may be positioned closer and further from the object to allow a user to visually adjust the illumination direction and extent of the illumination on objects within the scene. The user may also control parameters of the splat light illumination such as intensity, color, saturation, etc., directly via a graphical user interface, and/or through a programming interface.

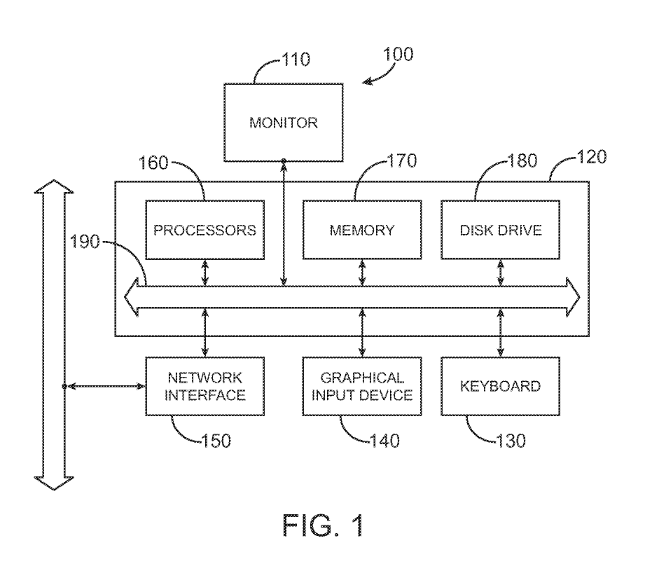

FIG. 1 is a block diagram of typical computer rendering system 100 according to an embodiment of the present invention. In one embodiment, computer system 100 typically includes a monitor 110, computer 120, a keyboard 130, a user input device 140, a network interface 150, and the like. In one embodiment, user input device 140 is typically embodied as a computer mouse, a trackball, a track pad, wireless remote, and the like. User input device 140 typically allows a user to select objects, icons, text and the like that appear on the monitor 110.

Embodiments of network interface 150 typically include an Ethernet card, a modem (telephone, satellite, cable, ISDN), (asynchronous) digital subscriber line (DSL) unit, and the like. Network interface ISO is typically coupled to a computer network as shown. In other embodiments, network interface 150 may be physically integrated on the motherboard of computer 120, may be a software program, such as soft DSL, or the like.

Computer 120 typically includes familiar computer components such as a processor 160, and memory storage devices, such as a memory 170 (e.g., random access memory (RAM>>, disk drives 180, and system bus 190 interconnecting the above components.

In one embodiment, computer 120 is a PC compatible computer having multiple microprocessors such as XEON™ microprocessor from Intel Corporation. Further, in the present embodiment, computer 120 typically includes a UNIX-based operating system.

Memory 170 and disk drive 180 are examples of tangible media for storage of data, audio/video tiles, computer programs, embodiments of the herein described invention including splat light source indicators, scene descriptors, object data files, shader descriptors, a rendering engine, output image files, texture maps, displacement maps, object pose data files, and the like. Other types of tangible media include floppy disks, removable hard disks, optical storage media such as CD-ROMS and bar codes, semiconductor memories such as flash memories, read-only-memories (ROMS), battery-backed volatile memories, networked storage devices, and the like.

In the present embodiment, computer system 100 may also include software that 30 enables communications over a network such as the HTTP, TCP/IP, RTP/RTSP protocols, and the like. In alternative embodiments of the present invention, other communications software and transfer protocols may also be used, for example IPX, udp or the like.

FIG. 1 is representative of computer rendering systems capable of embodying the present invention. It will be readily apparent to one of ordinary skill in the art that many other hardware and software configurations are suitable for use with the present invention. For example, the use of other micro processors are contemplated, such as PENTIUM™ or ITANIUM™ microprocessors; OPTEROWM or ATHLONXp™ microprocessors from Advanced Micro Devices, Inc; POWERPC G3™, 041′M microprocessors from Motorola, Inc.; and the like. Further, other types of operating systems are contemplated, such as WINDOWS® operating system such as WINDOWSXP®, WINDOWSNT®, or the like from Microsoft Corporation, SOLARIS from Sun Microsystems, LINUX, UNIX, MAC OS from Apple computer corporation, and the like.

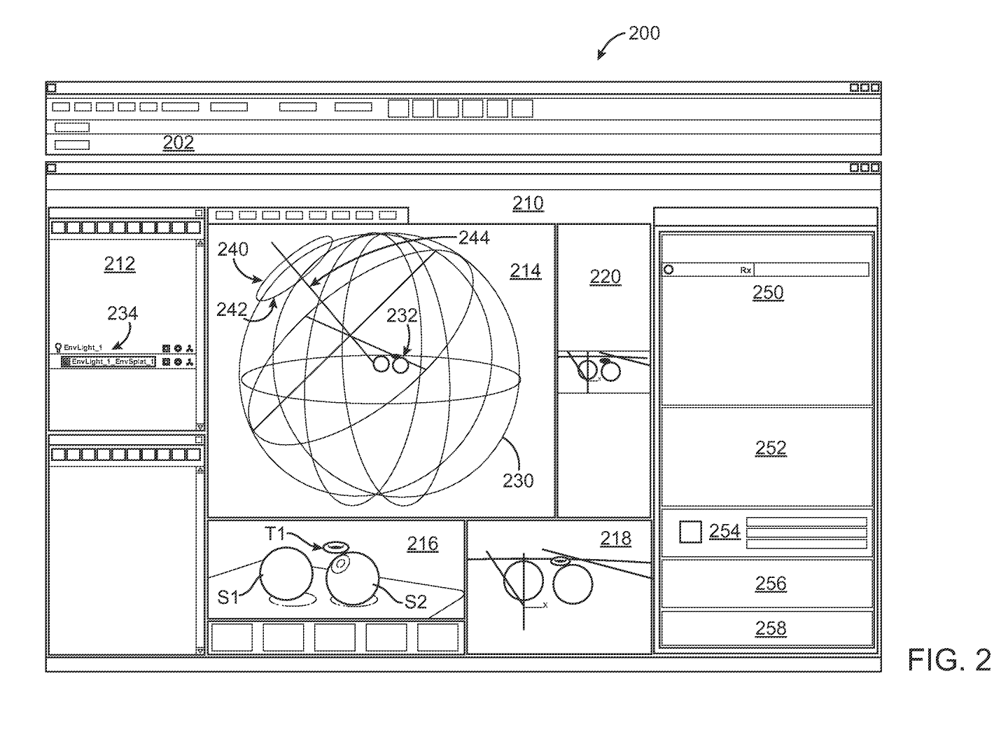

FIG. 2 is a high-level illustration of a graphical user interface (GUI) 200 of a computer graphics lighting application according to an embodiment of the invention. GUI 200 includes command console window 202 and animation window 210. Command console window 202 allows a user to work with animation files and images such as those stored in memory 170, on disk drive 180, etc. Command console window 202 also allows the user to perform a variety of lighting and scene manipulation and rendering functions such as, illumination control, rendering, editing, modify interface settings, save files, add layers, add/modify programming scripts, etc.

In one embodiment, animation window 210 includes lighting window 212, 3-D display 214, camera display window 220, rendering window 216, and lighting parameter window 250. For example, objects 232 as illustrated include three objects, sphere S1, sphere S2, and a doughnut shaped toroidal object T1. Objects 232 may be rendered as solid objects in rendering window 216, and in camera view window 220 to allow the user to see the illumination affect of the environmental lighting and shading.

Lighting window 212 provides a user such as an animator with a plurality of different types of lighting sources such as background lights, ambient lights, area lights, etc. Lighting window 212 also provides a splat light source selection control 234, which is used to select and configure splat lights in a scene.

3-D display 214 may be configured to display a 3-D image on two-dimensional (2-D) display such as monitor 110. In one embodiment, 3-D display 214 displays a lighting framework 230. An example of a lighting framework 230 is a sphere. Lighting framework 230 provides a user with a GUI suitable for configuring splat lights in a scene and/or on objects 232. For example, upon selecting a splat light in a scene, a corresponding splat light source indicator 240 is added to the lighting framework 230. A user can manipulate the splat light source indicator 240 to configure the attributes of the splat light. For example, a user can drag the splat light source indicator 240 to any screen position on the lighting framework 230. In an embodiment, the splat light source indicator 240 is restricted in movement to the lighting framework 230, such as the surface of the sphere in FIG. 2. By changing the position of the splat light source indicator 240, the direction attribute of the splat light, as indicated by direction axis 244 extending from the splat light source indicator 240 towards to the center of the sphere of the lighting framework 230, is changed.

As will be described further below, splat light source indicator 240 provides a visual reference (e.g., graphical display) to a user of a splat light function used to emulate an environmental light source such as a skylight, light bounced off a surface onto another surface, and the like. For example, by dragging or otherwise moving the splat light source indicator 240 to the top of the lighting framework sphere 230, the splat light is configured to direct environmental light downward. This can be used to add environmental light from an overhead light source, such as a skylight.

In addition to the splat light source indicator 240 used to specify a splat light direction, an embodiment of the invention also defines a splat light boundary 242. In an embodiment, the splat light boundary specifies the angular range of the splat light and is centered around the splat light source indicator 240. By dragging or otherwise resizing the splat light boundary 242, the angular range (and hence the lighting fall-off) of the splat light can be changed. For example, increasing the size of the splat light boundary 242 increases the angular range of the splat light. This allows points with normal vectors that deviate farther from the direction axis of the splat light to be illuminated. Conversely, decreasing the size of the splat light boundary 242 will decrease the angular range of the splat light, decreasing the range of deviation of normal vectors of points from the direction of a splat light that still receive illumination from the splat light. While splat light source indicator 240 is illustrated as a disc in this example, those skilled in the art will appreciate that any suitable shape may be used such as polygons, and the like. This allows the angular range (and hence the lighting fall-off) of the splat light to be different depending on the direction.

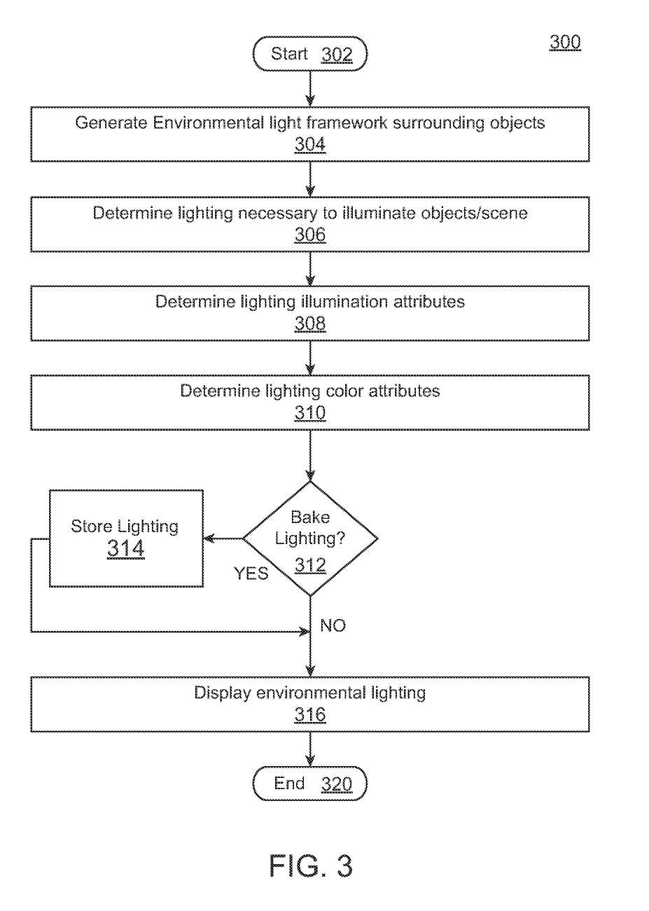

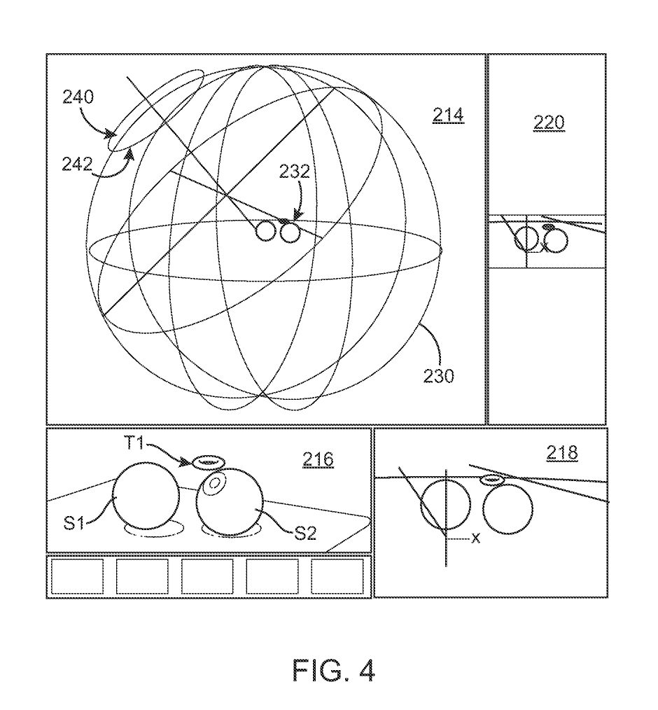

FIG. 3 is a high-level flow diagram illustrating one embodiment of a method 300 of generating a lighting framework 230. Method 300 may be entered into for example at step 302, when GUI 200 is activated. In one embodiment, at step 304 lighting framework 230 is displayed around objects (e.g., objects 232) and/or a scene displayed in display window 214. For example, as illustrated in FIG. 4, lighting framework 230 may be disposed about objects SI, 82, and T1 displayed in 3-D display 214. At step 306, the environmental lighting is provided by a user placing and positioning one or more splat light source indicators 240 on lighting framework 230.

In one embodiment, at step 308, the user adjusts the splat light illumination attributes such as color and intensity. Optional splat light attributes, such as shadowing, occlusion, reflection, specular, shadow density, and the like. The light source color is determined by user input in step 310. For example, a user may use a color ramp feature via lighting window 254 to set the color of the light source emissions and determine the shadow color using shadow color window 256, described further below.

At step 312, method 300 may determine from a user to “bake” the lighting configuration to save processing time. For example, once a lighting scheme has been established, processors 160 may store (e.g., bake) the resulting environmental lighting for faster rendering, for example, in a texture map format, for example, in memory 170. If at step 312 method 300 determines that the lighting should be baked, at step 316 the resulting lighting configuration and illumination results are stored. However, if the resulting illumination is not to be stored, then method 300 proceeds to step 316 to display a rendered image of the resulting illumination. For example, FIG. 4 illustrates an image in render display window 216 with objects S1, S2, and T1, illuminated according to the user's input. Method 300 ends at step 320.

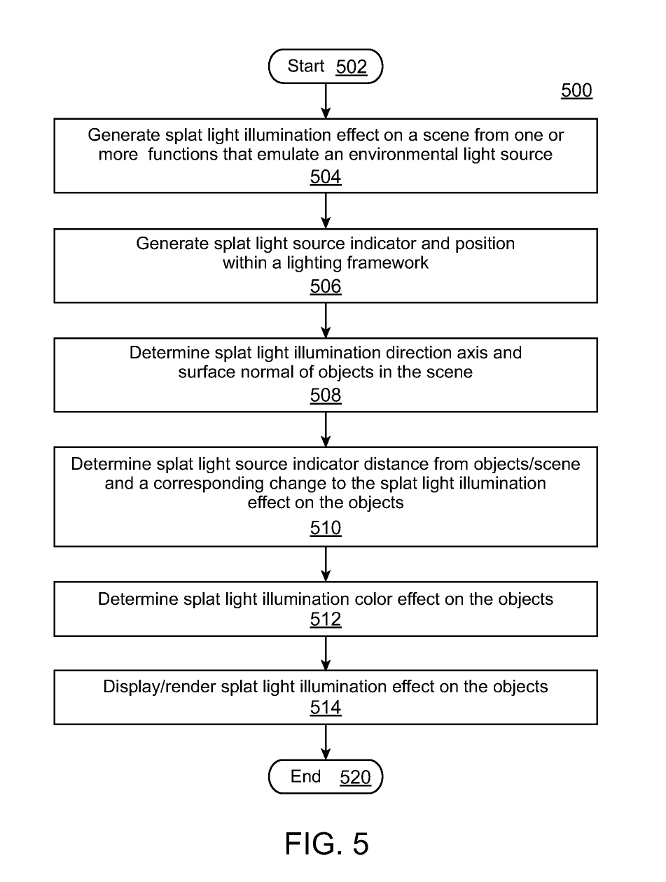

FIG. 5 is a high-level flow diagram illustrating one embodiment of a method 500 of generating a splat light illumination effect on an object in a scene. Method 500 may be entered into for example at step 502, when GUI 200 is activated. At step 504, a splat light is generated. In one embodiment, the splat light is defined mathematically using one or more functions stored for example in memory 170. Any suitable function may be used to generate a desired splat light illumination effect. For example, in one embodiment, a splat light illumination effect is provided using a normalized cosine function. Such a normalized cosine function has been observed to provide an environmental light with a natural looking illumination effect on objects in a scene. A normalized cosine function may be expressed as the dot product of two vectors, scaled to a 0 to 1 range, and has an output range from the −1 to 1 range. Advantageously, as the splat light is defined by one or more functions, the splat light avoids any physical representation which may be processing resource intensive, and defines its illumination effect as a processing efficient equation of the splat light illumination direction and the surface normal of the objects in the scene.

As a user may employ more than one splat light to a given scene, the combination of more than one splat light may be represented by the following equation:

$$SplatEnv = {\sum }_{nSplats} fsplat$$

where Splat Env represents a summation of one or more splat lights, which are summation of individual splat lights, fsplat, over the number of “nSplats” splat lights employed.

In a further embodiment, points with normal vectors outside of the angular range of the splat light are automatically set to receive no illumination from the splat light. The evaluation of the above equation can be bypassed for these points. Points with normal vectors inside the angular range of the splat light are evaluated using the above equation to determine their illumination from the splat light. This illumination can be further combined with illumination and shading from other light sources and object attributes. In an embodiment, the weighting of illumination from splat lights and other lights can be specified by the user using GUI 200.

In one embodiment, the function fsplat may be defined by the following equation: fsplat=pow (((Vsplat•Nsurface)+1)/2), I/Ssplat)*Csplat*Isplat where Vsplat=normalized splat light direction, Nsurface=normalized direction of the point to be illuminated by the splat light, Sspalt=splat light angular size, Csplat=splat light color, and Isplat=splat light intensity.

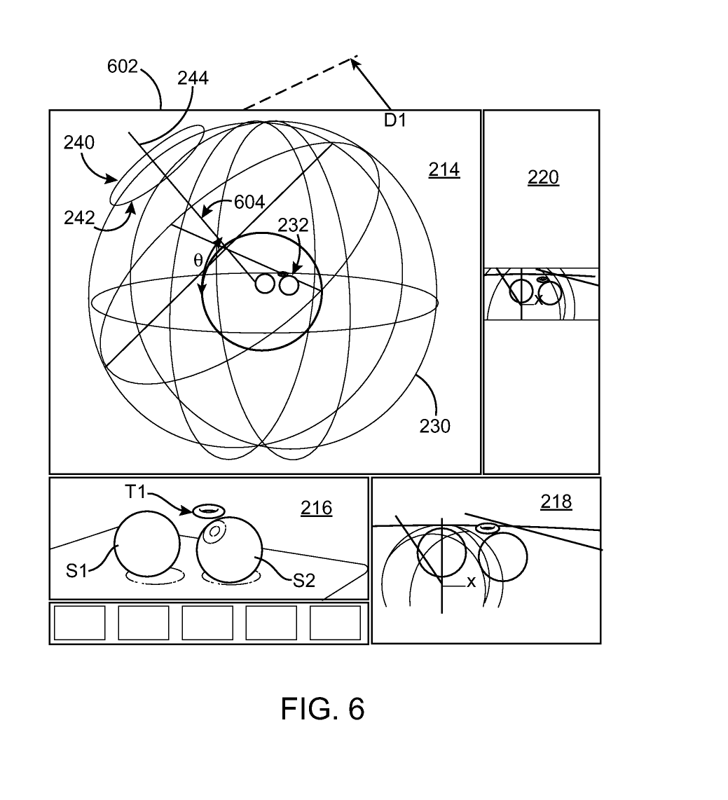

At step 506, splat light source indicator 240 is integrated with and positioned within lighting framework 230. For example, as illustrated in FIG. 6, splat light source indicator 240 is formed as a visual representation of the illumination effect of the one or more splat light functions and is positioned in conjunction with lighting framework 230. As illustrated in FIG. 6, a splat light frame 602 may be used to visually define the shape of the splat light source indicator 240 on the display and therefore the shape of the illumination effect of the splat light.

At step 508, as illustrated in FIG. 6, the user may modify the lighting axis 604 which illustrates the general lighting directional vector (e.g., illumination direction). Splat light source indicator 240 may be adjusted by the user to provide an angle of directed light with respect to lighting axis 604.

In one embodiment, at step 512, the illumination colors of the splat light illumination are determined. For example, a user may operate controls associated with the light color window 254 and/or shadow color window 256 to establish the color of the illumination and any resulting shadowing.

At step 514, the illumination color effect of one or more splat lights according to the placement of splat light source indicator(s) 240 is displayed. For example, as illustrated in FIG. 6, rendering window 216 displays the illumination of a splat light according to the placement of splat light source indicator 240 relative to objects S1, S2, and T1 based on the angle of directed illumination with respect to direction axis 244. Method 500 ends at step 510, when, for example, a user has finished adding splat light illumination to the objects 232.

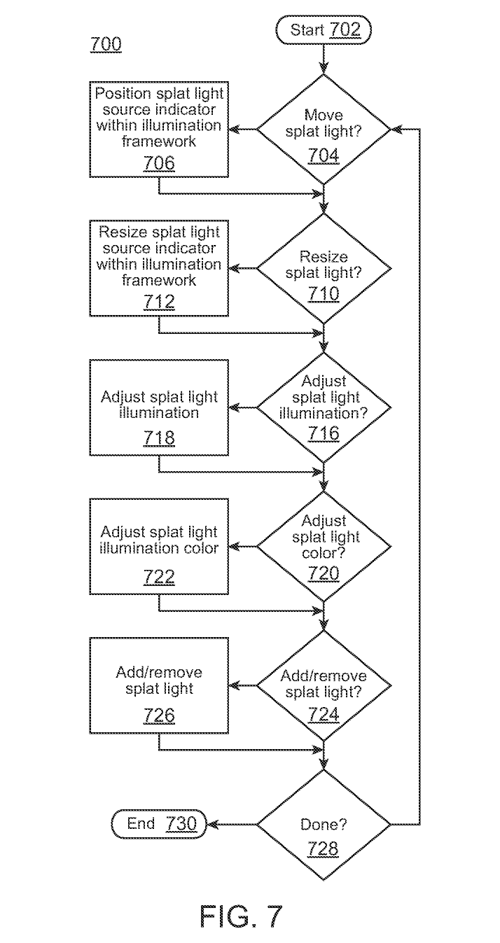

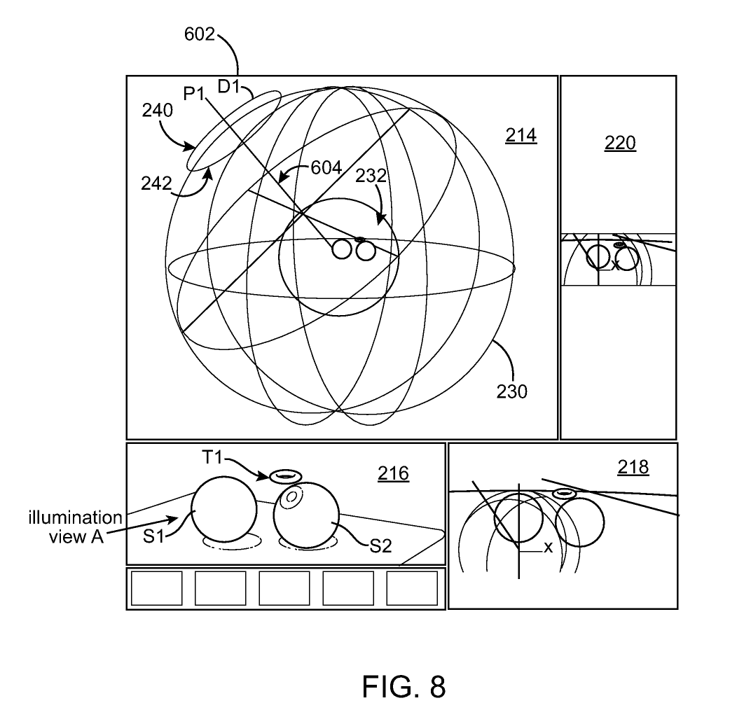

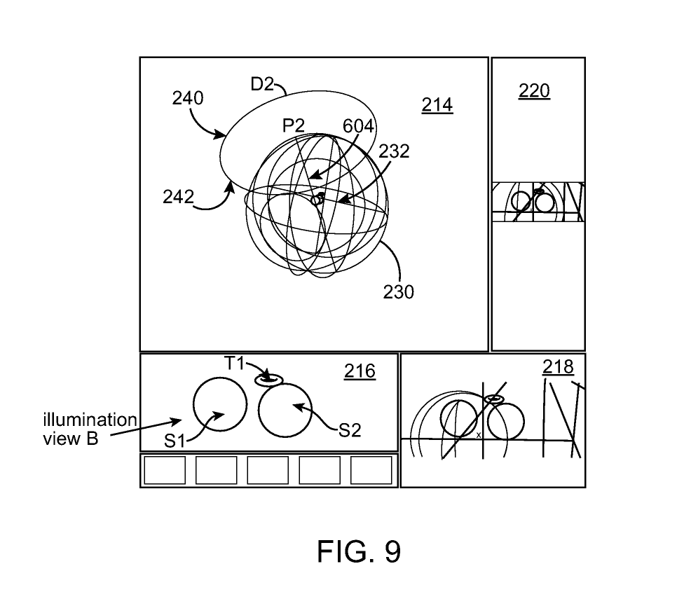

FIG. 7 is a high-level flow diagram illustrating one embodiment of a method 700 of manipulating parameters of a splat light. Method 700 may be entered into for example at step 702, when GUI 200 is activated. In one embodiment, method 700 determines if splat light source indicator 240 is to be moved on lighting framework 230 in response to a user varying 5 the position of splat light source indicator 240 to vary the direction of the splat light illumination effect on the objects 232. If so, at step 706 the position of splat light source indicator 240 is changed according to a user's input. For example, a user moves splat light source indicator 240 from a first position P1 illustrated in FIG. 8, to a second position P2 illustrated in FIG. 9. If repositioning of splat light source indicator is not desired, method 700 proceeds to step 710. In an embodiment, the splat light source indicator 240 is restricted in position by the lighting framework.

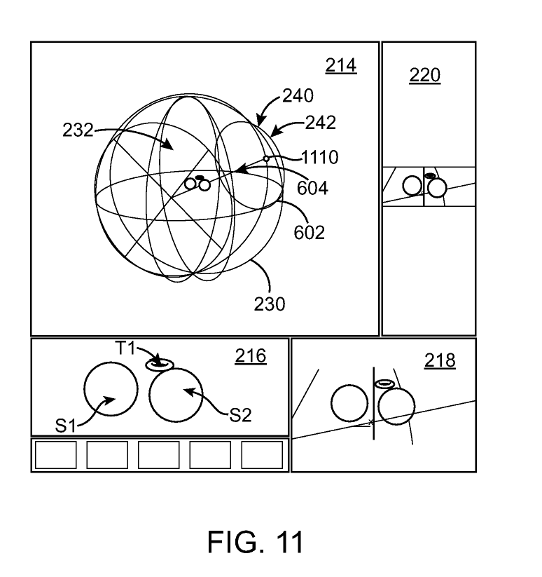

In one embodiment, as illustrated in FIG. 11, a splat light movement handle 1110 may be employed to allow a user to use a mouse, etc., to graphically move and position the splat light source indicator 240 about lighting framework 230.

At step 710, method 700 determines if a user wants to resize the splat light illumination effect on the scene which in one embodiment is indicated by a change in the size of splat light boundary 242. For example, as illustrated in FIG. 8, the size change of the splat light is reflected in the change in diameter of splat light boundary 242 from diameter D1 to diameter D2 illustrated in FIG. 9. If a shape size change is requested from a user, at step 712, method 700 changes the shape according to the user's input. If a shape change is not desired, method 700 proceeds to step 716.

In one embodiment, at step 716, method 700 determines if a change in illumination is desired. If changes to illumination are desired, at step 718 the illumination parameters of the splat light are altered such as illumination intensity, illumination coverage, and the like, which may be shown by changes in splat light source indicator 240. For example, as illustrated in FIG. 8, based on splat light parameter settings, objects 232 are illuminated per illumination view A as shown in rendering window 216. Illumination view A illustrates a partial illumination of objects 232. FIG. 9 illustrates illumination from splat light increased in size. The increase in splat light size is displayed as an increase in the size of source indicator 240, as shown in illumination view B. As shown in view B, the increase in splat light size illuminates a larger portion of the surfaces of objects 232 with respect to illumination view A.

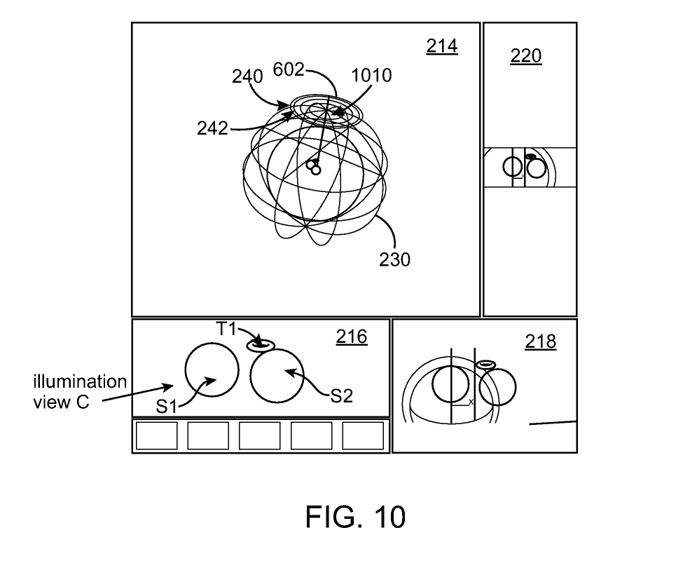

At step 720, method 700 determines if a change in splat light illumination color is desired. If changes to illumination color are desired, at step 722 the color parameters of the splat light, such as color spectrum, color saturation, and the like, are set using, for example, color ramp tools illustrated in color window 254 and shadow color window 256. Changes to splat light illumination color may be reflected in source indicators 240 as corresponding changes in the color of splat light source indicators 240. For example, FIG. 9 illustrates a first coloration of objects 232 in illumination view A, and FIG. 10 illustrates a second coloration of objects 232 in illumination view C, represented by a change in the surface shading of objects 123 between FIGS. 9-10.

In one embodiment, at step 724, method 700 determines if another splat light is to be added to the scene. If another splat light is to be added, at step 726 a new splat light illumination effect is defined as above using one or more functions, and the new splat light's corresponding splat light source indicator 240 is added to the display. As described above, any number of splat lights may be employed to illuminate objects and/or a scene, At step 728 if the user is finished manipulating and/or adding splat lights, method 700 ends at step 730 where for example, the user may render the scene and store the scene in a tangible media, such as user viewable media (e.g., film stock, printed media), magnetic media (e.g., hard disk, storage area network, etc), optical media (e.g., CD ROM, DVD ROM), Holographic memory, semiconductor media (e.g., flash memory, RAM, ROM) where a user may retrieve the representation of the scene from the tangible media and display the scene on a display such as monitor 110. However, if the user is not finished then method 700 proceeds to step 704.

Further aspects of embodiments of the invention are illustrated in the attached figures, Additional embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention.

Any of the above described steps may be embodied as computer code on a computer readable medium. The computer readable medium may reside on one or more computational apparatuses and may use any suitable data storage technology.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of illuminating a scene, the method comprising:
receiving a splat light specification including a splat light direction, a splat light angular range, and a splat light color;
selecting a point potentially illuminated by the splat light, wherein the point includes a normal vector defining an orientation for the point;
determining if the normal vector is within the splat light angular range; and
in response to the determination that the normal vector is within the splat light angular range, applying the splat light color to the point.

2. A method of illuminating a scene, the method comprising:
receiving a splat light specification including a splat light direction, a splat light angular range, and a splat light color;
selecting a point potentially illuminated by the splat light, wherein the point includes a normal vector defining an orientation for the point and a shader defining an illumination of the point in response to light sources;
determining if the normal vector is within the splat light angular range; and
in response to the determination that the normal vector is within the splat light angular range, determining an illuminated value for the point, wherein the illuminated value of the point includes a component defined directly by the splat light color and independent of the shader.

3. A method of specifying environmental illumination in a scene, the method comprising:
displaying a lighting framework;
receiving via a graphical user interface a splat light position on the lighting framework;
defining a splat light direction based on the splat light position on the lighting framework;
receiving a splat light angular range via a graphical user interface, wherein the splat light angular range is indicated on the lighting framework;
receiving a splat light color via the graphical user interface;
selecting a point potentially illuminated by the splat light, wherein the point includes a normal vector defining an orientation for the point;
determining if the normal vector is within the splat light angular range; and
in response to the determination that the normal vector is within the splat light angular range, applying the splat light color to the point.
